(19) United States
(12) Patent Application Publication
(10) Pub. No.: US 2010/0281695 A1
(43) Pub. Date: Nov. 11, 2010

(54) POWER TOOL HAVING INTERCHANGEABLE ATTACHMENTS

(76) Inventor: Fangjie Nie, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/775,564

(22) Filed: May 7, 2010

(30) Foreign Application Priority Data
May 8, 2009 (CN) 200920045162.1

(51) Int. Cl. B25F 3/00; B26B 15/00

(52) U.S. Cl. 30/122; 30/277.4

(57) ABSTRACT

The present invention discloses a power tool having a main body portion and at least one interchangeable cutting tool carrier. A motor and a transmission mechanism are mounted in the main body portion and the cutting tool carrier includes a cutting tool assembly which includes a connection mechanism. The transmission mechanism includes a driving device which is mounted on the driving shaft and may be coupled with the connection mechanism. The transmission mechanism also has a stationary element and a movable element, each having a magnet mounted on a surface. Due to the magnetic force, the moving element and the driving device are able to move relative to the stationary element to allow for automatic alignment of the driving device and the connection mechanism of the cutting tool elements.

### CROSS-REFERENCE TO RELATED APPLICATIONS

This application claims priority under 35 U.S.C. §119 to CN 200920045162.1 filed May 8, 2009, which is hereby incorporated by reference.

### FEDERALLY SPONSORED RESEARCH OR DEVELOPMENT

Not Applicable.

### TECHNICAL FIELD

The present invention relates to a power tool, and more specifically, to an adaptable power tool that can be used with different types of interchangeable cutting tool attachments.

### BACKGROUND OF THE INVENTION

Many power tools are adaptable to allow for their use across different purposes. The adaptability increases convenience and reduces expenses for a user of the power tool. Specifically, a main body of a power tool can be connected with different cutting tool attachments to allow for many different uses of the power tool. For example, a garden tool may have a main body portion and a plurality of different cutting tool carriers. Each cutting tool carrier can be equipped with several different types of cutting tool attachments, such as short blades for cutting grass and long blades for pruning shrubs. Each of the various cutting tool carriers can be interchangeably connected to the main body portion to provide a multi-use garden tool.

As explained above, the garden tool can accomplish many different functions by connecting the main body portion with different cutting tool carriers. As a result, a user is able to accomplish many different gardening tasks by purchasing only one machine. However, the above mentioned garden tool of the prior art does not adequately provide for the alignment of the main body portion with the connection mechanism when the cutting tool carrier is installed on the main body portion. Specifically, in the prior art, the user must first rotate a driving shaft of the driving device to a predetermined position and then move the blade of the attachment to a corresponding position to allow for installation. This tedious connection and alignment process can be very cumbersome and time-consuming for a user of the power tool.

### SUMMARY OF THE INVENTION

In order to overcome the disadvantages and deficiencies in the prior art, this invention provides an improved power tool which has an automatic alignment function when interchanging the cutting tool elements and thus can be operated conveniently.

The power tool provided in the present invention includes a main body portion and at least one interchangeable cutting tool carrier. A motor and a transmission mechanism are mounted in the main body portion, and the cutting tool carrier includes a cutting tool assembly which includes a connection mechanism. The transmission mechanism includes a driving device which is mounted on the driving shaft and cooperates with the connection mechanism. The transmission mechanism also has a stationary element and a moving element which can move together with the driving device and can provide mutual repulsion force therebetween.

Under effect of the repulsive force, the moving element may be moveable relative to the stationary element, and the driving device can be moveable relative to the stationary element since the moving element can be moved together with the driving device. Upon assembling the main body portion and the cutting tool carrier of the power tools, the driving device used for driving the cutting tool elements can move to allow for the automatic alignment of the driving device and the connection mechanism of the cutting tool.

### BRIEF DESCRIPTION OF THE DRAWINGS

The present invention will be further described with reference to accompanying figures and preferred embodiments.

FIG. 1 is an illustrative view of a preferred embodiment of a garden tool according to the present invention.

FIG. 2 is an illustrative view of an interchangeable cutting tool carrier.

FIG. 3 is an illustrative view of partial internal structure of the garden tool shown in FIG. 1.

FIG. 4 is a plan view of a gear shown in FIG. 3.

FIG. 5 is a cutaway view of the gear shown in FIG. 4.

### DETAILED DESCRIPTION

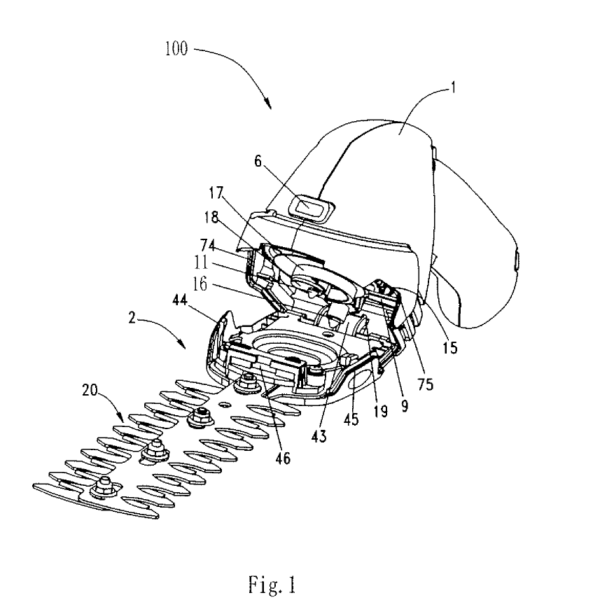

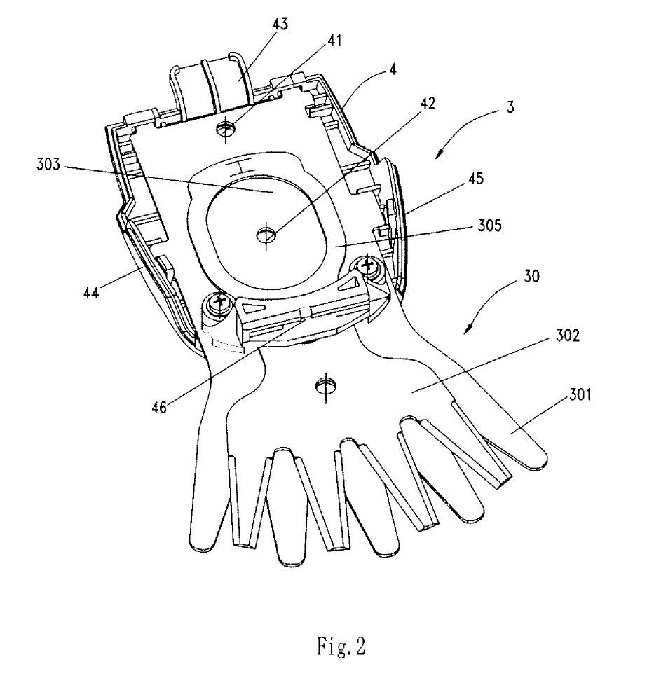

FIG. 1 shows a preferred embodiment of a garden tool according to the present invention. The garden tool 100 can be used for cutting grass, pruning shrubs and cutting other types of vegetation. The garden tool 100 includes a main body portion 1 which can be connected with different cutting tool carriers to achieve different functions. As shown in FIGS. 1 and 2, a long cutting tool carrier 2 used for pruning shrubs and a short cutting tool carrier 3 for cutting grass, respectively, are shown. Each of cutting tool carriers 2 and 3 includes a base 4 and a cutting tool element installed thereon. The cutting tool carrier 2 for pruning shrubs is provided with a pair of longer blades 20 which can move relative to each other in a linear reciprocating motion along a front-rear direction. The cutting tool carrier 3 for cutting grass is provided with a pair of shorter blades 30 where at least one blade can swing relative to the other blade in a swinging motion.

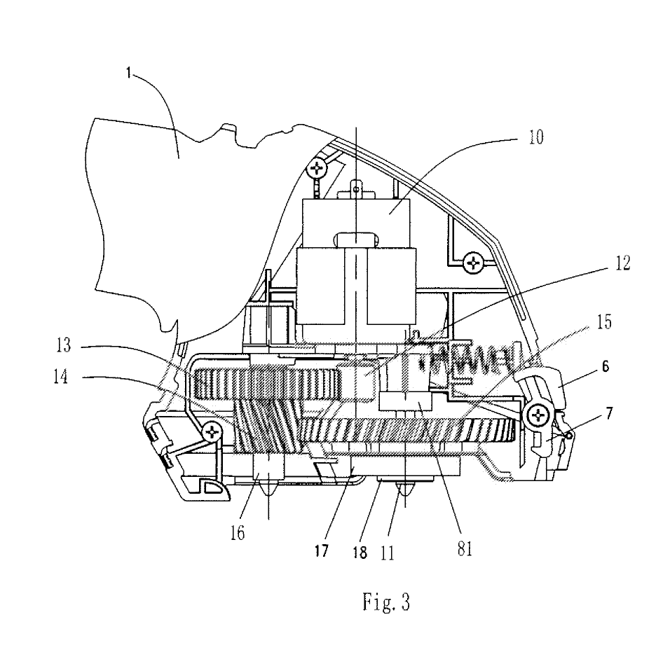

As shown in FIG. 3, the main body portion 1 of the garden tool 100 has a motor 10 installed therein. A deceleration mechanism is connected to the output end of the motor 10 to reduce speed output from the motor 10. The deceleration mechanism is a gear transmission mechanism including four gears 12, 13, 14 and 15, wherein the gear 12 is mounted on the output shaft of the motor 10, the gears 13 and 14 are mounted on the shaft 16, and the gear 15 is installed on the shaft 11. The gear 12 and the gear 13 are installed to engage with each other and the gear 14 and the gear 15 are also installed to engage with each other. The shafts 16, 11 are arranged parallel to each other and are conical at the free ends. The two shafts 16 and 11 extend out from the main body portion 1 so they may be connected with the cutting tool carrier. The shaft 11 is coupled with a driving device for driving the blades. In this embodiment, the driving device is an elliptical device which includes a large elliptical wheel 17 and a small elliptical wheel 18. The large and small elliptical wheels 17, 18 are fixed on the gear 15 and overlap with each other, and the relative position between the two elliptical wheels is permanent. In other embodiments, the two elliptical wheels can be made integrally. The large and small elliptical wheels 17, 18 can be respectively mated with the connection mechanisms of the blades 20, 30, i.e. oval-shaped holes, so as to drive the blades to move.

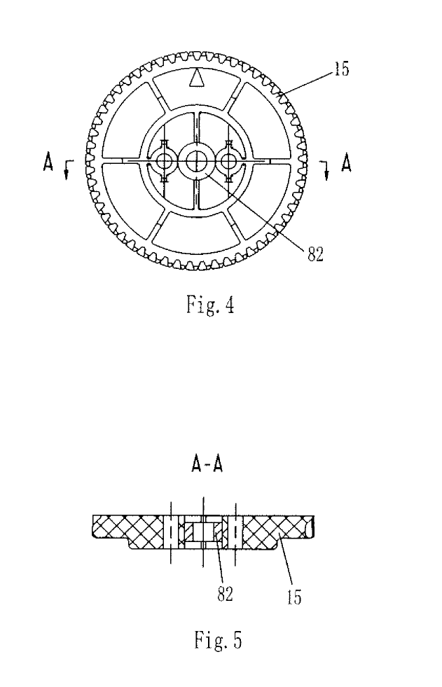

Upon assembling the main body portion 1 of the garden tool 100 and the cutting tool carrier, the garden tool 100 also includes a pair of magnets in order to achieve automatic alignment of the two elliptical wheels 17, 18 device and the oval-shaped holes in the blades 20, 30. Referring to FIG. 3, a first magnet 81 is permanently installed on the shaft 11. Referring to FIG. 4 and FIG. 5, a second magnet 82 is mounted in the center hole of the gear 15 by interference fit, and the gear 15 and the second magnet 82 are movably installed on the shaft 11. The elliptical wheels 17, 18 can move together with the gear 15 and the second magnet 82 due to the fixed connection between the elliptical wheels 17, 18 and the gear 15. Under the assembled state, the first and second magnets 81, 82 are located on the shaft 11 and opposite to each other with the same magnetism. Therefore, the gear 15 and the elliptical wheels 17, 18 tend to move downwards under the action of the magnetic force which is repulsive due to magnetism forces of a same polarity.

As shown in FIG. 1, a stopper 9 extends inwardly from the housing of the main body portion 1 to limit the displacement of the downward movement of the gear 15 and the elliptical wheels 17, 18. In this embodiment, the stopper is a stop rod. Therefore, the gear 15 can move between the first magnet 81 and the stop rod 9 along the shaft 11. As shown in FIG. 3, the height of the gear 14 is significantly larger than the height of the gear 15. This height arrangement allows the gear 15 to engage with the gear 14 at any time during the up-down displacement of the gear 15.

The automatic alignment process for the cutting tool element of the garden tool 100 will be described hereinafter by an example of using the cutting tool carrier 3 for cutting grass. As shown in FIG. 2, the cutting tool carrier 3 is provided with the base 4 and the cutting tool element. The base 4 has two longitudinal arranged holes 41, 42. The spacing between the two holes is equal to the spacing between the shaft 16 and the shaft 11 so that the shafts 16, 11 can be inserted into the holes 41, 42, respectively. The base 4 further includes a rear engaging sheet 43, left and right engaging sheets 44, 45 and a groove 46. When assembling the rear engaging sheet 43 can be inserted into the hole 19 of the main body portion 1, and the left and right engaging sheets 44, 45 can respectively engage with the left and right engaging slots 74, 75 on the main body portion 1. The front end of the main body portion 1 is provided with a button 6 which can be operated to drive a hook 7 connected with it to rotate so as to engage with or disengage from the groove 46. The cutting tool element 30 includes a lower blade 301 and an upper blade 302. In this embodiment, the lower blade 301 is permanently installed on the base 4, and the upper blade 302 is movably installed on the lower blade 301. The upper blade 302 has an oval-shaped hole 303 as a connection mechanism at one end thereof which may be mated with the large elliptical wheel 17, so as to drive the upper blade 302 to swing in a swinging motion to implement the action for cutting grass.

When the cutting tool carrier 3 is connected to the main body portion 1 to form a grass trimmer, the rear engaging sheet 43 of the base 4 are inserted into the hole 19 of the main body portion 1 and the shafts 16, 11 are aligned with the holes 41, 42 and inserted therein. The cutting tool carrier is then further closed so that the left and right engaging sheets 44, 45 engage with the left and right engaging slots 74, 75, and the hook 7 is mated with the groove 46. Under this assembled state, the cutting tool carrier 3 is installed on the main body portion 1, but the elliptical device of the main body portion 1 might not be aligned with the oval-shaped hole 303 in the blade 302. As a result, the elliptical wheel 17 may press the edge 305 of the oval-shaped hole 303, and the upward reaction of the oval-shaped hole 303 causes the elliptical device and the gear 15 to move upwardly by overcoming the magnetic force. When this occurs, the motor 10 is powered to drive the elliptical wheel 17 to rotate along with the gear 15. When the elliptical wheel 17 rotates away from the edge 305 of the oval-shaped hole 303, the elliptical wheel 17 and the gear 15 may move downwardly and fall into the oval-shaped hole 303 under the action of the magnetic field. The elliptical wheel 17 continues to rotate so as to drive the blade 302 to move. For the cutting tool carrier with only one moveable blade 302, the small elliptical wheel 18 on the shaft 11 remains in idle state. For the cutting tool carrier with two moveable blades 20, the large and small elliptical wheels 17, 18 may be mated with the large and small oval-shaped holes on the two moveable blades 20. This allows the two blades 20 to be driven to move simultaneously.

In the above-mentioned embodiments, the automatic alignment of the elliptical device and the connection mechanism of the cutting tool elements is achieved by mounting a pair of magnets with the same magnetic poles opposite to each other on the shaft 11. However, the present invention is not limited to the magnet and it may be replaced by other materials which can produce repulsive force. In addition, those skilled in this art would easily envision that such device with the automatic alignment function for the cutting tool elements can also be used for other types of the power tools with the requirement for replacing the cutting tools elements and is not limited to the garden tool embodiments described above.

The power tools disclosed in this invention are not limited to the contents mentioned above and the structures shown in the figures. Any obvious modifications, substitutions or changes to the shapes and the positions of other components based on the spirit of the present invention will be regarded as falling within the scope of this invention.

What is claimed is:

1. A power tool, comprising:
a main body portion and at least one interchangeable cutting tool carrier;
wherein a motor and a transmission mechanism are mounted in the main body portion, and the cutting tool carrier includes a cutting tool assembly which includes a connection mechanism;
the transmission mechanism includes a driving device which is mounted on the driving shaft and coupled to the connection mechanism
the transmission mechanism further including a first and a second element which provide a mutual repulsion force therebetween.

2. The power tool according to claim 1, wherein the first element is a stationary element.

3. The power tool according to claim 1, wherein the second element is a moving element.

4. The power tool according to claim 1, wherein the first element and the second element can move together with the driving device.

5. The power tool according to claim 1, wherein the first element is a stationary element having a first magnet mounted thereon.

6. The power tool according to claim 5, wherein the second element is a moving element having a second magnet mounted thereon, and further wherein the first magnet and the second magnet are orientated such that the same magnetic poles are opposite to each other.

7. The power tool according to claim 2, wherein the first element is securely coupled to the driving shaft.

8. The power tool according to claim 3, wherein the second element is moveably installed on the driving shaft and can move together with the driving device on the driving shaft.

9. The power tool according to claim 1, wherein the transmission mechanism further comprises a gear, and the second element is installed in a center hole of the gear.

10. The power tool according to claim 9, wherein the driving device is coupled with the gear.

11. The power tool according to claim 1, wherein the driving device is an elliptical device.

12. The power tool according to claim 1, wherein the cutting tool carrier has a plurality of engaging elements, and the main body portion has a plurality of engaging slots, the engaging elements of the cutting tool carrier being able to couple with the engaging slots of the main body portion.

13. The power tool according to claim 1, wherein the main body portion has two extended shafts, the cutting tool carrier further having two longitudinally arranged holes such that the two extended shafts of the main body portion being able to couple with the two longitudinally arranged holes of the cutting tool carrier.

14. The power tool according to claim 1, wherein the main body portion further comprises a stopper extending inwardly to restrict the displacement of the driving device.
